(19) United States
(12) Patent Application Publication
(10) Pub. No.: US 2016/0265592 A1
(43) Pub. Date: Sep. 15, 2016

(54) AXIAL CAGE FOR CYLINDRICAL ROLLING ELEMENTS

(71) Applicant: SCHAEFFLER TECHNOLOGIES AG & CO. KG, Herzogenaurach (DE)

(72) Inventors: Wolfgang Fugel, Nurnberg (DE); Andreas Kirschner, Aurachtal (DE)

(73) Assignee: Schaeffler Technologies AG & Co. KG, Herzogenaurach (DE)

(21) Appl. No.: 15/031,046

(22) PCT Filed: Sep. 23, 2014
(86) PCT No.: PCT/DE2014/200497

§ 371 Date: Apr. 21, 2016

(30) Foreign Application Priority Data
Oct. 22, 2013 (DE) 10 2013 221 363.8

(51) Int. Cl. F16C 33/54; F16C 33/56; F16C 19/30

(52) U.S. Cl. CPC F16C 33/546; F16C 19/305; F16C 33/541; F16C 33/56; F16C 2202/04; F16C 2204/66

(57) ABSTRACT

The invention relates to an axial cage for cylindrical rolling elements, which is formed substantially of a thin-walled annular disc with a profiled cross section, which is formed by an inner radial rim shaped on the inner edge of the annular disc, by an outer radial rim shaped on the outer edge of the annular disc, and by a center beading connected to the radial rims via axial inner and outer intermediate profile sections. A number of uniformly spaced, rectangular cage pockets are removed from the beading and the adjacent intermediate profile sections, between which cage pockets an identical number of pocket webs are formed connecting the rims with each other, by which the cylindrical rolling elements are held in the cage pockets at a uniform distance to each other and guided in the circumferential direction. The annular disc according to the invention is formed of a through-hardened and tempered, high-alloy spring steel with a maximum hardness of 450 HV, wherein any conventional spring steel with a minimum material thickness of 15% to 25% of the diameter of the rolling elements can be used as the spring steel for the annular disc.

### FIELD OF THE INVENTION

The invention relates to an axial cage for cylindrical rolling elements.

### BACKGROUND

DE 1 174 113 A discloses a generic axial cage for axial bearing needles which substantially comprises a thin-walled annular disc having a profiled cross-section which is formed by an inner radial rim which is formed on the inner edge of the annular disc, an outer radial rim which is formed on the outer edge of the annular disc and a central bead which is connected to the radial rims by inner and outer intermediate profile portions. From the central bead and the adjacent intermediate profile portions, there are a number of rectangular cage pockets which are uniformly spaced apart from each other and between which there are formed an identical number of pocket webs which connect the rims to each other and by which the cylindrical rolling members which are constructed as bearing needles are retained in the cage pockets with uniform spacing from each other and guided in a peripheral direction.

Such axial cages generally comprise a non-alloyed steel, such as, for example, of the type DC 03, and are produced in known manner from an endless sheet metal strip in several processing steps in a step type punching/drawing tool, without cutting, in such a manner that an annular disc which is connected to the sheet metal strip by two lateral retention webs is first punched, the central bead and the outer radial rim are subsequently formed in the annular disc, the inner diameter of the axial cage is subsequently punched out and the inner radial rim is formed on the annular disc, then the cage pockets are punched out and finally the outer diameter of the axial cage is also punched out. Finally, the completely formed axial cages are further case-hardened and tempered or nitrocarburized in order to increase the resistance thereof to wear.

However, it has been found in practice that in particular the case-hardening and tempering or the nitro-carburization of the punched axial cages which are intended to be carried out in a separate operating step are very time-consuming and costly, as a result of which the economic viability of the cage production is called into question. With regard to the quality of the axial cages which can be achieved, the case-hardening and tempering or the nitro-carburization of the axial cages has also been found to be disadvantageous since the thermal processing of the axial cages results in occurrences of hardening distortion and the nitro-carburization of the axial cages results in tolerance fluctuations, as a result of which there are occurrences of non-roundness or even grinding of the cage on the needle ball races or jamming of the bearing needles in the cage pockets. Furthermore, the known steel cages can be constructed with only one surface-hardening operation and consequently with a relatively low resistance to wear and tensile strength, since through-hardening of the steel cages would lead to embrittlement of the material and ultimately premature breakage of the axial cage under operating conditions. For this reason, consequently, production of axial cages from steel sheets with very small cross-sections is also not possible at all since such materials, as a result of their low level of strength, would in principle completely through-harden and consequently become brittle.

### SUMMARY

Based on the disadvantages of the known prior art set out, an object of the invention is therefore to configure for cylindrical rolling elements an axial cage which can be produced without case-hardening and tempering or nitro-carburization and which is distinguished by no occurrences at all of hardening distortion and by an increased resistance to wear and tensile strength and a lower level of tolerance fluctuations.

According to the invention, this object is achieved with an axial cage produced from an annular disc which comprises a through-hardened and tempered, highly alloyed spring steel with a maximum hardness of 450 HV.

The invention is consequently based on the notion which is not immediately obvious of using as the starting material for the production of the cage a highly alloyed spring steel which is already through-hardened and tempered before the processing operation. Since, as a result of the use of such a spring steel, the standard thermal processing operation of the axial cage can consequently be dispensed with, the high punching precision thereof is maintained and occurrences of hardness distortion and tolerance fluctuations can no longer occur. Furthermore, as a result of the use of spring steel for the axial cage, it is possible to produce the cage from extremely thin strip material and nonetheless to construct it in a dimensionally stable manner since the tensile strength of spring steel with respect to the previously used strip steel is higher by up to a factor of 10. The use of spring steel for the axial cage also affords the possibility of already equipping the axial cages with rolling elements in the punching machine since the surface-finishing operation which is conventionally carried out in a separate operating step before the provision with rolling elements can now be omitted.

Preferred embodiments and advantageous developments of the axial cage which is constructed in accordance with the invention are described in the dependent claims.

Accordingly, in the axial cage which is constructed according to the invention there is provision for any commercially available spring steel to be able to be used as the spring steel for the annular disc, for example, a spring steel of the type C 75 SQT.

According to another feature of the axial cage which is constructed according to the invention is that the spring steel for the annular disc has a minimum material thickness of from 15% to 25% of the diameter of the rolling element. In the preferred use of bearing needles having a diameter of 0.8 mm, the material thickness of the spring steel for the axial cage is consequently between 0.12 and 0.2 mm.

Finally, as an advantageous embodiment of the axial cage which is constructed according to the invention, it is further proposed that the cross-section profile of the annular disc be constructed as an edge-free undulating profile whose central bead has the same radial height as the lateral rims and that the intermediate profile portions and the central bead are in the form of identical radii or sine curves which are arranged one beside the other in a descending and ascending manner. Constructing the central bead with the same radial height as the lateral rims is carried out in this instance for the purposes of reliable retention of the rolling elements in the cage pockets. The construction of the cross-section profile of the annular disc as an edge-free undulating profile from identical radii or sine curves which are arranged one beside the other is carried out in contrast for reasons of the hardness of the spring steel which is used in order to prevent possible risk of breakage of the axial cage caused by profiled edges.

### BRIEF DESCRIPTION OF THE DRAWINGS

A preferred embodiment of the axial cage constructed in accordance with the invention will be explained in greater detail below with reference to the appended drawings in which:

FIG. 1 is a three-dimensional overall view of an axial needle cage which is constructed according to the invention; and

FIG. 2 is the cross-section A-A through the axial needle cage constructed according to the invention in accordance with FIG. 1.

### DETAILED DESCRIPTION OF THE PREFERRED EMBODIMENTS

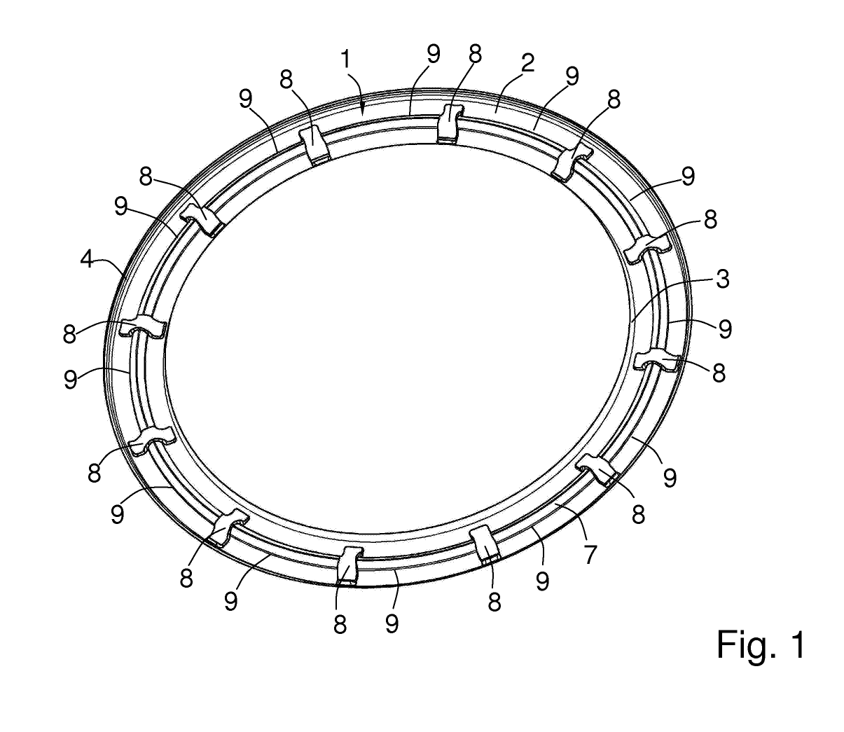

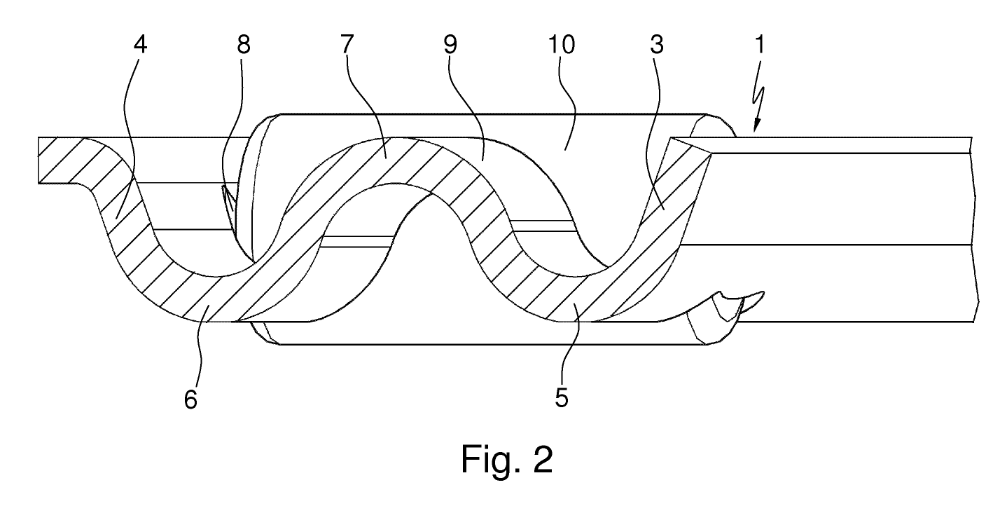

FIG. 1 clearly shows an axial cage 1, which is for cylindrical rolling elements 10 which are constructed as bearing needles, and substantially comprises a thin-walled annular disc 2 with a profiled cross-section. The profiled cross-section in this instance, as can be seen in FIG. 2, is formed by an inner radial rim 3 which is formed on the inner edge of the annular disc 2, an outer radial rim 4 which is formed on the outer edge of the annular disc 2 and a central bead 7 which is connected to the radial rims 3, 4 by axially inner and outer intermediate profile portions 5, 6. From the bead 7 and the adjacent intermediate profile portions 5, 6, there are removed a number of rectangular cage pockets 8 which are uniformly spaced apart from each other and between which there are formed an identical number of pocket webs 9 which connect the rims 3, 4 to each other and by which the cylindrical rolling elements 10 are retained in the cage pockets 8 with uniform spacing from each other and guided in a peripheral direction.

In order to prevent occurrences of hardness distortion caused by case-hardening and tempering or tolerance fluctuations caused by nitro-carburization in the axial cage 1 shown, a through-hardened and tempered, highly alloyed spring steel with a maximum hardness of 450 HV is used according to the invention as a starting material for the annular disc 2 thereof. In this case, for example, a spring steel of the type C 75 SQT which has a minimum material thickness of from 15% to 25% of the diameter of the rolling elements 10 is used as a spring steel for the annular disc. The cross-section profile of the annular disc 2, as can clearly be seen in FIG. 2, in order to prevent breakages of the cage and for secure retention of the rolling elements 10 in the cage pockets 8, is further constructed as an edge-free undulating profile whose central bead 7 has the same radial height as the lateral rims 3, 4, wherein the intermediate profile portions 5, 6 and the central bead 7 are in the form of identical radii or sine curves which are arranged one beside the other in a descending and ascending manner.

### LIST OF REFERENCE NUMERALS

1 Axial cage
2 Annular disc
3 Inner radial rim
4 Outer radial rim
5 Inner intermediate profile portion
6 Outer intermediate profile portion
7 Central bead
8 Cage pockets
9 Pocket webs
10 Rolling element

1. An axial cage for cylindrical rolling elements, comprising a thin-walled annular disc having a profiled cross-section which is formed by an inner radial rim formed on an inner edge of the annular disc, an outer radial rim formed on an outer edge of the annular disc and a central bead connected to the radial rims by axially inner and outer intermediate profile portions, from the bead and the adjacent intermediate profile portions, there are provided a number of rectangular cage pockets which are uniformly spaced apart from each other and between which there are formed an identical number of pocket webs which connect the rims to each other and by which the cylindrical rolling elements are retained in the cage pockets with uniform spacing from each other and guided in a peripheral direction, the annular disc comprises a through-hardened and tempered, highly alloyed spring steel with a maximum hardness of 450 HV.

2. The axial cage as claimed in claim 1, wherein the spring steel is a spring steel of the type C 75 SQT.

3. The axial cage as claimed in claim 1, wherein the spring steel for the annular disc has a minimum material thickness of from 15% to 25% of a diameter of the rolling element.

4. The axial cage as claimed in claim 1, wherein a cross-sectional profile of the annular disc is constructed as an edge-free undulating profile with the central bead having a same radial height as the rims.

5. The axial cage as claimed in claim 3, wherein the intermediate profile portions and the central bead are formed with identical radii or sine curves which are arranged one beside the other in a descending and ascending manner.
